(19) United States
(12) Patent Application Publication
(10) Pub. No.: US 2009/0153349 A1
(43) Pub. Date: Jun. 18, 2009

(54) Handheld controller and method of controlling a controlled object by detecting a movement of a handheld controller

(75) Inventors: Chin-Hung Lin, Taichung (TW); Jheng-Hei Pan, Taichung (TW); Jung-Wei Chen, Taichung (TW)

Correspondence Address: Lin, Chin-Hung, P.O. Box 44-2049, Taipei, 10668, TW

(73) Assignee: OMNI MOTION TECHNOLOGY CORPORATION

(21) Appl. No.: 12/081,433

(22) Filed: Apr. 16, 2008

(30) Foreign Application Priority Data
Dec. 17, 2007 (TW) 096148245

(51) Int. Cl. G06F 13/42

(52) U.S. Cl. 340/825

(57) ABSTRACT

The present invention discloses a method of controlling a controlled object by detecting a movement of a handheld controller, wherein the handheld controller comprises a central processing unit, a sensor, and a database, wherein the sensor is operated to detect the movement of the handheld controller, and the database is applied to store correction parameters. First, the sensor is applied to detect a movement of the handheld controller, to generate a signal, and to transfer the signal to the central processing unit, wherein the signal contains coordinates of the movement in a first coordinate system. After applying the central processing unit to send a request to the database to inquire a corresponding correction parameter of said signal, the database is applied to send the correction parameter to the central processing unit. Thereafter, the central processing unit is applied to generate a controlling command by multiplying the correction parameter to the signal, wherein the controlling command comprises coordinates in a second coordinate system. After that, the controlling command is transferred to the controlled object to direct the controlled object to move in the second coordinate system in accordance with the controlling command.

### BACKGROUND OF THE INVENTION

(1) Field of the Invention

This invention is related to a handheld controller, and more specifically, to a method of manipulating a controlled object by detecting the movements of the handheld controller.

(2) Description of the Prior Art

At present, most remote controls still employ the traditional means of operation (As shown in FIG. 12). By shifting operating rod 34 to start an indirect sensing mode, the handhold remote control device 33 is capable of controlling object 35 independently.

In addition, FIG. 13 shows a schematic diagram of the mouse-cursor system in the prior art. The cursor 32 of the mouse 30 can only be moved on the monitor 31 by moving the mouse 30 on a planar desk.

Although the remote-controlled object can be controlled by the remote-control by using the operating rod, by moving fingers to push the operating rod not only lacks of variability, but also loses the feeling of an objective control. Therefore, the design of the prior art requires further improvements.

In addition, the traditional mouse is able to respond quicker for a precise operation, but the use of this mouse is limited to be operated on a flat surface. With the spatial limitation, the prior art cannot fully satisfy the requirements of users.

Furthermore, the analytic theories and computing equations of the prior art are extremely complex. Therefore the computation should be performed by a high-performance embedded system, affecting the cost and the power-consumption with its revolutionary technology.

Based on the foregoing shortcomings, manufacturers continue developing an apparatus for controlling a mouse cursor in a three-dimensional space. The detection method of a traditional mouse is replaced by using a mechanical gyroscope to overcome the spatial limitation, so as to achieve a control mode by operating at any posture in a space.

However, it's not desirable to control the cursor by using the handheld mouse. Since the origin of the mouse-cursor system deviates from the origin of the human hand, it's necessary to perform the calibration step frequently. Moreover, the prior art uses mechanical gyroscope to sense the motion of the remote controllers, having the shortcomings such as large volume, poor sensitivity, long recovery time, and high power consumption. Furthermore, the detection of any angular deviation is not stable, and thus errors occur frequently. Obviously, this prior art also requires improvements.

### SUMMARY OF THE INVENTION

The main object of the present invention is to provide a method of controlling a controlled object by detecting a movement of a handheld controller.

The other object of the present invention is to provide a handheld controller.

The present invention discloses a method of controlling a controlled object by detecting a movement of a handheld controller, wherein the handheld controller comprises a central processing unit, a sensor, and a database, wherein the sensor is operated to detect the movement of the handheld controller, and the database is applied to store correction parameters. First, the sensor is applied to detect a movement of the handheld controller, to generate a signal, and to transfer the signal to the central processing unit, wherein the signal contains coordinates of the movement in a first coordinate system. After applying the central processing unit to send a request to the database to inquire a corresponding correction parameter of the signal, the database is applied to send the correction parameter to the central processing unit. Thereafter, the central processing unit is applied to generate a controlling command by multiplying the correction parameter to the signal, wherein the controlling command comprises coordinates in a second coordinate system.

After that, the controlling command is transferred to the controlled object to direct the controlled object to move in the second coordinate system in accordance with the controlling command.

The present invention also discloses a handheld controller, which comprises a central processing unit, a sensor, a database, and a communication apparatus. The sensor is applied to detect a movement of the handheld controller, to generate a signal, and to send the signal to the central processing unit. The signal contains coordinates of the movement in a first coordinate system.

The database is applied to store correction parameters. The central processing unit sends a request to the database to inquire a corresponding correction parameter of the signal after receiving the signal. After receiving the request, the database sends the correction parameter to the central processing unit. The central processing unit generates a controlling command by multiplying the correction parameter to the signal, wherein the controlling command comprises coordinates in a second coordinate system.

The communication apparatus is applied to transfer the controlling command to a controlled object. After receiving the controlling command, the controlled object moves in the second coordinate system in accordance with the controlling command.

### BRIEF DESCRIPTION OF THE DRAWINGS

FIG. 1A discloses the block diagram of the handheld controller of the present invention.

FIG. 1B discloses the structure diagram of the handheld controller of the present invention.

FIG. 2 discloses the structure diagram of the first embodiment for the handheld controller of the present invention.

FIG. 3 discloses the structure diagram of the second embodiment for the handheld controller of the present invention.

FIG. 4 discloses the structure diagram of the third embodiment for the handheld controller of the present invention.

FIG. 5 discloses the diagram for the correction parameters.

FIG. 6 is a diagram of the output of the gyroscope.

FIG. 7 is a flow chart of enabling the handheld controller.

FIG. 8 is a flow chart of the method of controlling a controlled object by detecting a movement of a handheld controller.

FIG. 9 is a schematic diagram of the integrated remote-control apparatus of the present invention.

FIG. 10 is a schematic diagram of another embodiment of the present invention.

FIG. 11 is a schematic diagram of another embodiment of the present invention.

FIG. 12 is a schematic diagram of the remote-control apparatus in the prior art.

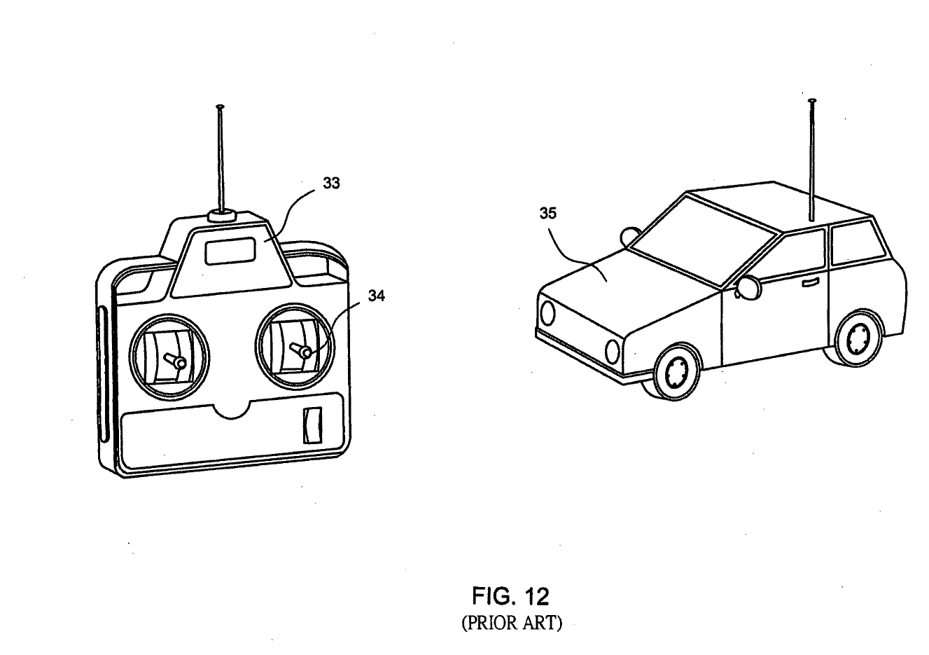

FIG. 13 is a schematic diagram of the mouse-cursor system in the prior art.

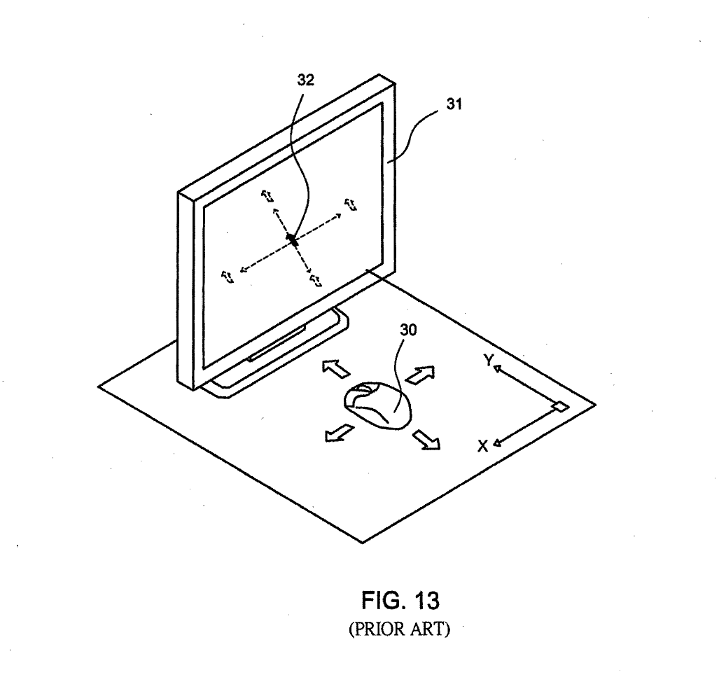

FIG. 14 is a schematic diagram of another embodiment of the present invention.

### DETAILED DESCRIPTION OF THE PREFERRED EMBODIMENTS

The details and the preferred embodiments of the present invention are disclosed as follows:

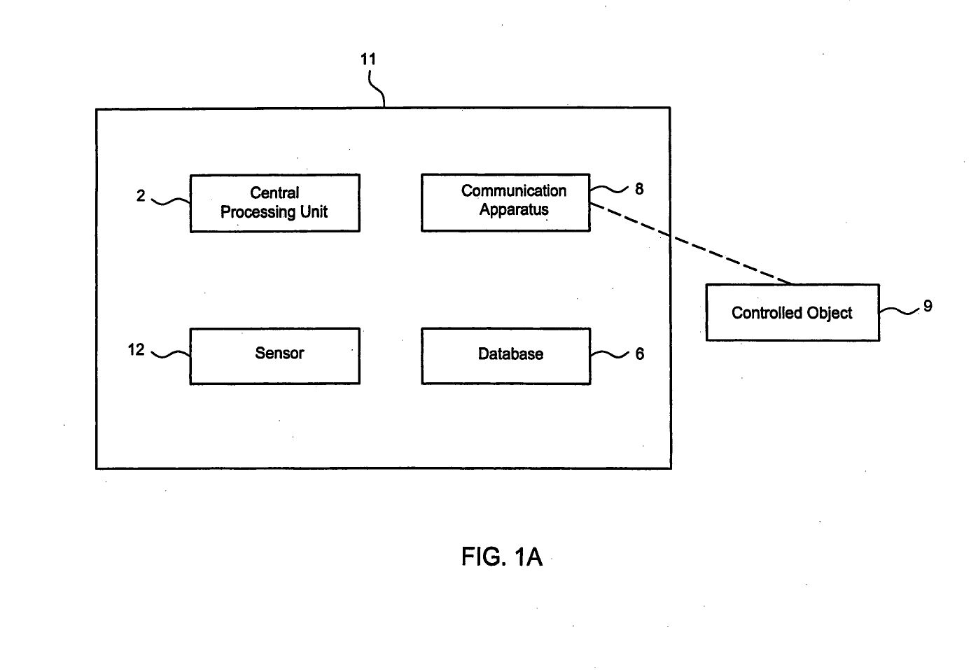

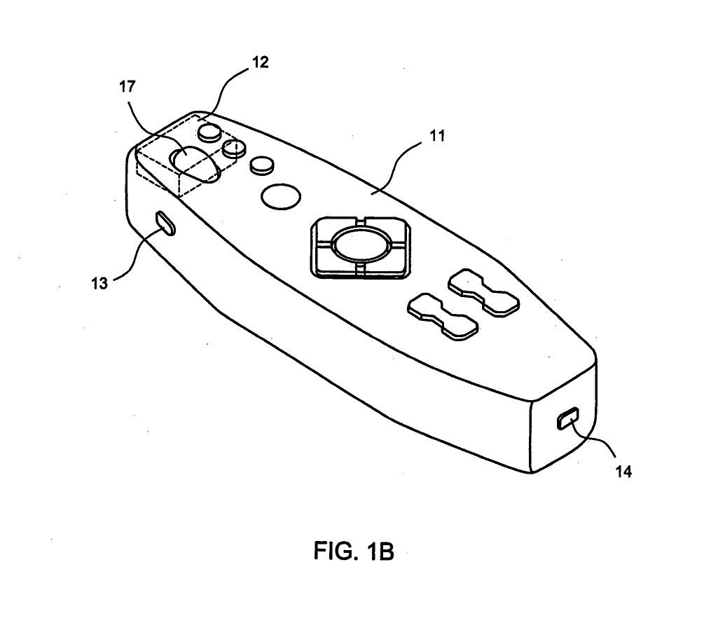

Referring first to FIG. 1A, it discloses the block diagram of the handheld controller of the present invention. The handheld controller 11 disclosed in the present invention is comprised of a central processing unit 2, a sensor 12, a database 6, and a communication apparatus 8. The central processing unit 2 is applied to perform the control and computation for the handheld controller 1. The sensor 12 is applied to detect a movement of the handheld controller 1, to generate a signal, and then to send the signal to the central processing unit 2. The signal contains coordinates of the movement in a first coordinate system.

After receiving the signal, the central processing unit 2 sends a request to the database 6 to inquire a corresponding correction parameter of the signal. According to an embodiment of the present invention, the first coordinate system is set on a wrist, an elbow, a shoulder, or other position of human being. According to an embodiment of the present invention, the central processing unit 2 and the database 6 are integrated into a microcontroller.

The database 6 is applied to store the correction parameters. After receiving the request from the central processing unit 2, the database sends the correction parameter to the central processing unit 2. After receiving the correction parameter, the central processing unit 2 generates a controlling command by multiplying the correction parameter to the signal, wherein the controlling command comprises coordinates in a second coordinate system.

The communication apparatus 8 is applied to transfer the controlling command to a controlled object 9. After receiving the controlling command, the controlled object 9 moves in the second coordinate system in accordance with the instruction.

Referring next to FIG. 1B, it discloses the structure diagram for the handheld controller of the present invention. The handheld controller 11 is comprised of a roller 17, a sensor 12, a start button 13, and a calibration button 14. The sensor 12 starts to detect the movement of the handheld controller 11 in the first coordinate system after pressing the start button, and a user's wrist or elbow joint works as a fulcrum to move or rotate the handheld controller 11 in any posture, so that the controlled object performs a corresponding two-dimensional or three-dimensional movement. According to an embodiment of the present invention, the sensor 12 is enabled or disabled by pressing or releasing the start button 13 to generate an enabling signal or a disabling signal. According to another embodiment of the present invention, the sensor 12 is enabled by pressing the start button 13 to generate an enabling signal and disabled by pressing the start button 13 again to generate a disabling signal.

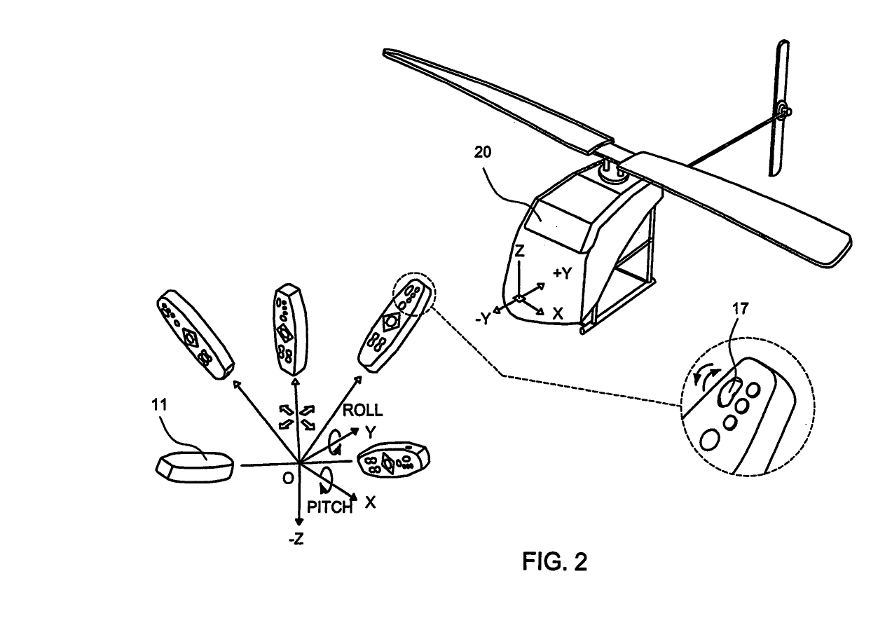

FIG. 2 discloses the structure diagram of the first embodiment for the handheld controller of the present invention. According to this embodiment, the handheld controller 11 is a handheld remote controller with a roller 17, and the controlled object is a remote-controlled airplane 20. The sensor 12 is a MEMS multi-axis gyroscope. According to this embodiment, the first coordinate system is a two-dimensional or three-dimensional angular velocity coordinate system, and the second coordinate system is a two-dimensional or three-dimensional coordinate system. Both coordinate systems are Cartesian coordinate system.

When a user presses the start button 13 of the handheld controller 11, the user's wrist or elbow joint works as a fulcrum to move or rotate the handheld controller 11 on the X-Y plane. Accordingly, the remote-controlled airplane 20 is controlled to move on the X-Y plane. Moreover, the remote-controlled airplane 20 is controlled to move up or down by turning the roller 17 forward or backward, respectively.

FIG. 2 discloses the structure diagram of the first embodiment for the handheld controller of the present invention. The handheld controller 11 is rotated along the X-axis for a PITCH movement, running around the Point O as the center. It's assumed that ω_{X} is the angular velocity detected by using the PITCH-axis of the gyroscope, Δθ stands for the relative angular movement of the PITCH axis, and Δyₕ stands for the relative sampling movement of a remote-controlled airplane along the Y-axis. The relation between ω_{X} and Δyₕ can be represented as the following Equation 1:

Δyₕ=S_{fX}·S_{1X}·Δθ≈S_{fX}·S_{1X}·Tω_{X}=S_{fX}·S_{2X}ω_{X} (1)

Where S_{fX} is a scale factor of an X-axis gyroscope, S_{1X} is a correction parameter for converting the angular motion of the PITCH-axis into a linear movement along the Y-axis, and T stands for a constant sampling period. It's also noted that S_{2X}=TS_{1X}, and the scale factor and the correction parameter are stored in the database 6.

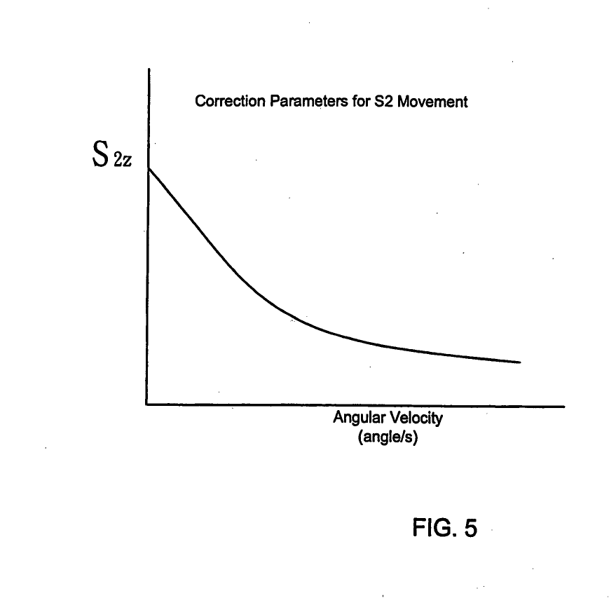

FIG. 5 discloses the diagram for the correction parameters. According to FIG. 5, S_{2X} is a function of ω_{X}, and the numeric value of S_{2X} decreases as the value of ω_{X} increases, so as to achieve a saturated value. The main function of the curve is to compensate the insignificant ω_{X} which is generally ignored as noise of hand shaking. Furthermore, another function of this curve is to correct the discrepancy with the actual movement caused by a larger measurement value and a longer recovery time.

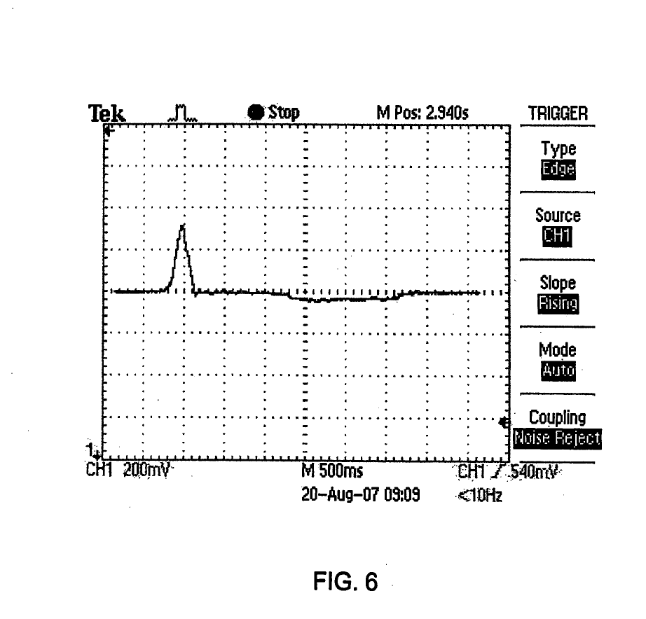

FIG. 6 is a diagram of the output of the gyroscope. In FIG. 6, an input device with a gyroscope sensor moved back and forth with a constant angle of 15 degrees. The sensitivity of the gyroscope sensor measured by an oscilloscope is 33.3 mV/(°/sec), and the actual measured value of the scale factor S_{fX} of the gyroscope is 10. Theoretically, the areas above and below the bias should be identical, but actually the area of the upper path is 15.34 degrees and the area of the lower path is 11.28 degrees under the condition of T=2 ms. As a result, a larger angular velocity ω_{X} is corresponding to a smaller S_{2X}, and a smaller angular velocity ω_{X} is corresponding to a larger S_{2X}. The real-time computation by using the Equation (1) allows the upper area similar to the lower area, so as to achieve the effect of precisely controlling the movement of a controlled object or a screen cursor.

In FIG. 2, the movement of the handheld controller 11 is detected by an X-Y-axis output of a multi-axis gyroscope measured by a single chip, wherein the X-axis movement Δxₕ is obtained by an equation as follows:

Δxₕ≈S_{fY}·S_{2Y}ω_{Y} (2)

Where ω_{Y} is the angular velocity of the roll-axial gyroscope, S_{fY} is the scale factor of Y-axis gyroscope, and S_{2Y} and ω_{Y} have a functional relationship.

In order to control the controlled object 9 by using the handheld controller 11, the angular velocities (ω_{X},ω_{Y}) of the handheld controller 11 in the first coordinate system, i.e., the body frame coordinate system, are first detected. The detected signals with amounts and directions in the first coordinate system are then transformed to the second coordinate system i.e., the object frame coordinate system, forming the amounts and directions (Δxₕ, Δyₕ). The Equation (3) below is used to calculate the movement relationship between the handheld controller 11 and the controlled object 9.

$${[ \begin{matrix}Δ {x}_{h} \\ Δ {y}_{h}\end{matrix} ]}_{object \cdot frame} = [ \begin{matrix}0 & {S}_{fY} {S}_{2 Y} \\ {S}_{fx} {S}_{2 X} & 0\end{matrix} ] \cdot {[ \begin{matrix}{ω}_{X} \\ {ω}_{Y}\end{matrix} ]}_{body \cdot frame} \qquad ( 3 )$$

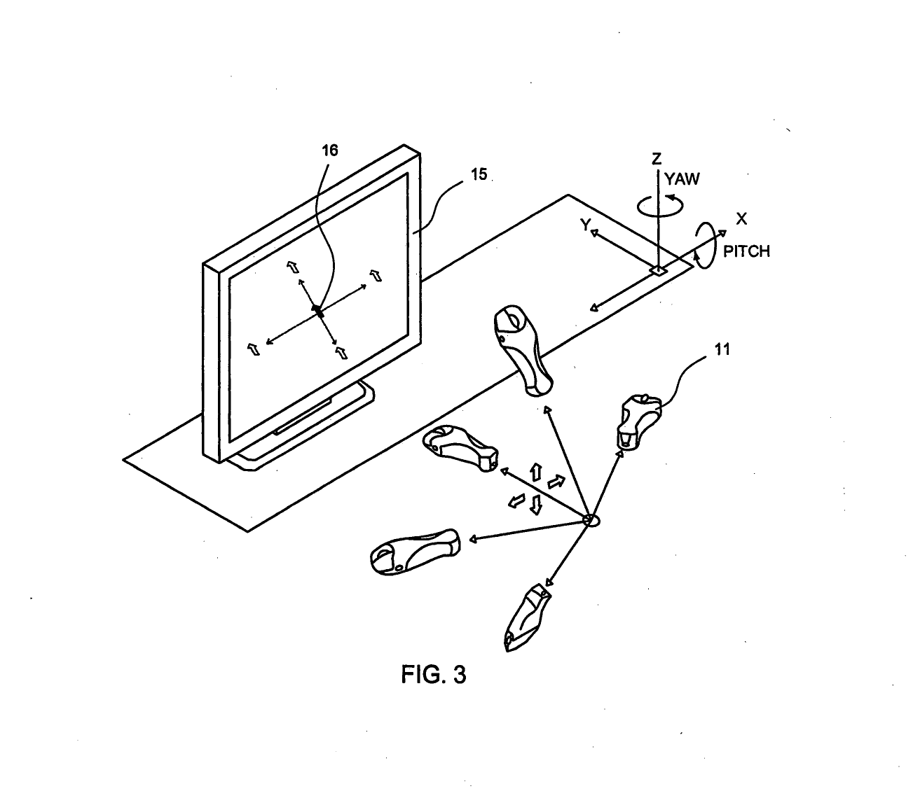

FIG. 3 discloses the structure diagram of the second embodiment for the handheld controller of the present invention. According to this embodiment, the handheld controller 11 is a three-dimensional mouse, and the controlled object is a cursor on a monitor.

It's assumed that ω_{Z} is the angular velocity detected by using the YAW-axis of the gyroscope, Δψ stands for the relative angular movement of the YAW-axis, and Δxₚ stands for the relative sampling displacement of a cursor along the X-axis. The relation between ω_{Z} and Δxₚ can be represented as follows:

Δxₚ=S_{fZ}·S_{1Z}·Δω≈S_{fZ}·S₁·Tω_{Z}=S_{fZ}·S_{2Z}·ω_{Z} (4)

Where S_{fz} is a scale factor of the Z-axis gyroscope, and S_{1z} is a correction parameter for converting the angular movement of the YAW-axis into a linear movement along the X-axis. It's also noted that S_{2z}=TS_{1z}.

The detected movement of the apparatus is an X-Z-Y-axis output of a multi-axis gyroscope measured by a single chip, wherein the z-axis displacement Δzₚ can be calculated by the following Equation (5):

Δzₚ≈S_{fX}·S_{2X}·ω_{X} (5)

Where ω_{X} is the angular velocity of the Pitch-axial gyroscope, S_{fx} is the scale factor of X-axis gyroscope, and S_{2X} and ω_{X} have a functional relationship. The Y-axis displacement Δyₚ can be calculated by the following Equation (6):

Δyₚ≈S_{fY}·S_{2Y}·ω_{Y} (6)

Where ω_{Y} is the angular velocity of the Roll-axis, S_{fY} is a scale factor of a Y-axis gyroscope, and S_{2Y} and ω_{Y} have a functional relationship.

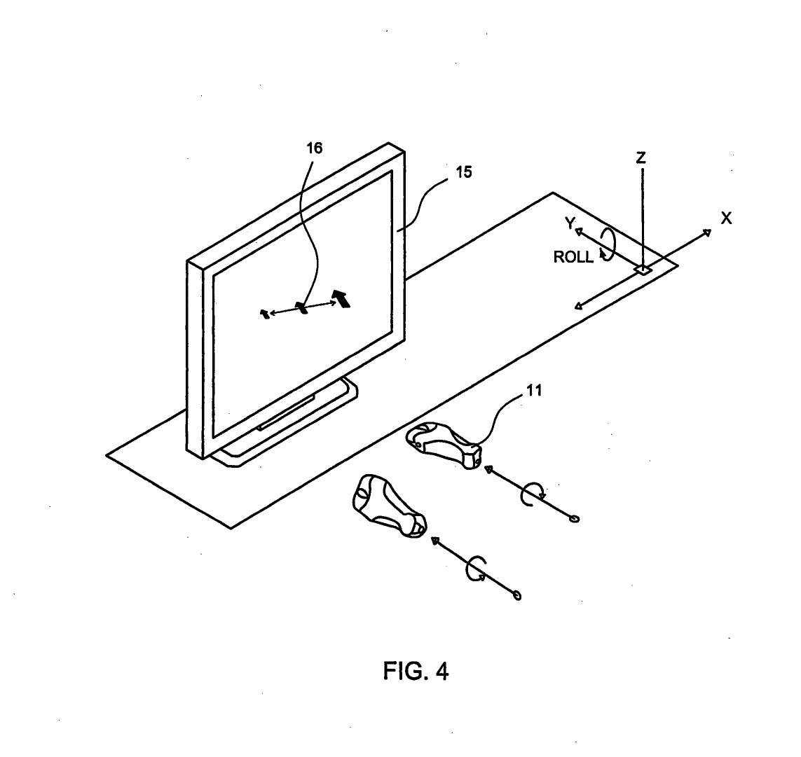

FIG. 4 discloses the structure diagram of the third embodiment for the handheld controller of the present invention. By rotating the handheld controller 11 clockwise or counterclockwise, the cursor or controlled object 16 on the monitor 15 is directed to move forward or backward along the Y-axis, respectively.

In order to control the controlled object 9 by using the handheld controller 11 in a three-dimensional space, the angular velocities (ω_{X},ω_{Y},ω_{Z}) of the handheld controller 11 in the first coordinate system, i.e., the body frame coordinate system, are first detected. The detected signals with amounts and directions in the first coordinate system are then transformed to the second coordinate system i.e., the object frame coordinate system, forming the amounts and directions (Δxₚ, Δyₚ, Δzₚ). The Equation (7) below is used to calculate the movement relationship between the handheld controller 11 and the controlled object 9.

$$\begin{matrix}{[ \begin{matrix}Δ {x}_{p} \\ Δ {y}_{p} \\ Δ {z}_{p}\end{matrix} ]}_{object \cdot frame} = [ \begin{matrix}0 & 0 & {S}_{fZ} {S}_{2 Z} \\ 0 & {S}_{fY} {S}_{2 Y} & 0 \\ {S}_{fX} {S}_{2 X} & 0 & 0\end{matrix} ] \cdot [ \begin{matrix}{ω}_{X} \\ {ω}_{Y} \\ {ω}_{Z}\end{matrix} ] \\ = {K}_{W} \cdot {S}_{W} \cdot {[ \begin{matrix}{ω}_{X} \\ {ω}_{Y} \\ {ω}_{Z}\end{matrix} ]}_{body \cdot frame}\end{matrix} \qquad ( 7 )$$

Where K_{w} is a matrix for coordination transformation as follows:

$${K}_{W} = [ \begin{matrix}{k}_{11} & {k}_{12} & {k}_{13} \\ {k}_{21} & {k}_{22} & {k}_{23} \\ {k}_{31} & {k}_{32} & {k}_{33}\end{matrix} ] \qquad ( 8 )$$

In this example, k₁₃=k₂₂=k₃₁=1, and other kᵢⱼs are zero. S_{W} stands for the matrix for correcting the motion signals.

$${S}_{W} = [ \begin{matrix}{s}_{fX} {s}_{2 X} & 0 & 0 \\ 0 & {s}_{fY} {s}_{2 Y} & 0 \\ 0 & 0 & {s}_{fZ} {s}_{2 Z}\end{matrix} ] \qquad ( 9 )$$

Furthermore, the analog three-axis outputs are then digitalized and transformed into the cursor movements in the X-Z-Y coordinates. Finally, the cursor 16 is moved on the monitor accordingly.

According to another embodiment of the present invention, the sensor is an accelerometer. Accordingly, the first coordinate system is an angular movement coordinate system, and the second coordinate system is a linear movement coordinate system.

According to another embodiment of the present invention, the sensor is a tilt sensor. Accordingly, the first coordinate system is an angular movement coordinate system, and the second coordinate system is a linear movement coordinate system.

According to another embodiment of the present invention, the sensor is a gyroscope combining an accelerometer. Accordingly, the first coordinate system is a three-dimensional coordinate system, in which two coordinate axes are angular movement coordinate axes, and one coordinate axis is an angular velocity coordinate axis. The second coordinate system is a three-dimensional coordinate system, in which two coordinate axes are linear movement coordinate axes, and one coordinate axis is an angular movement coordinate axis.

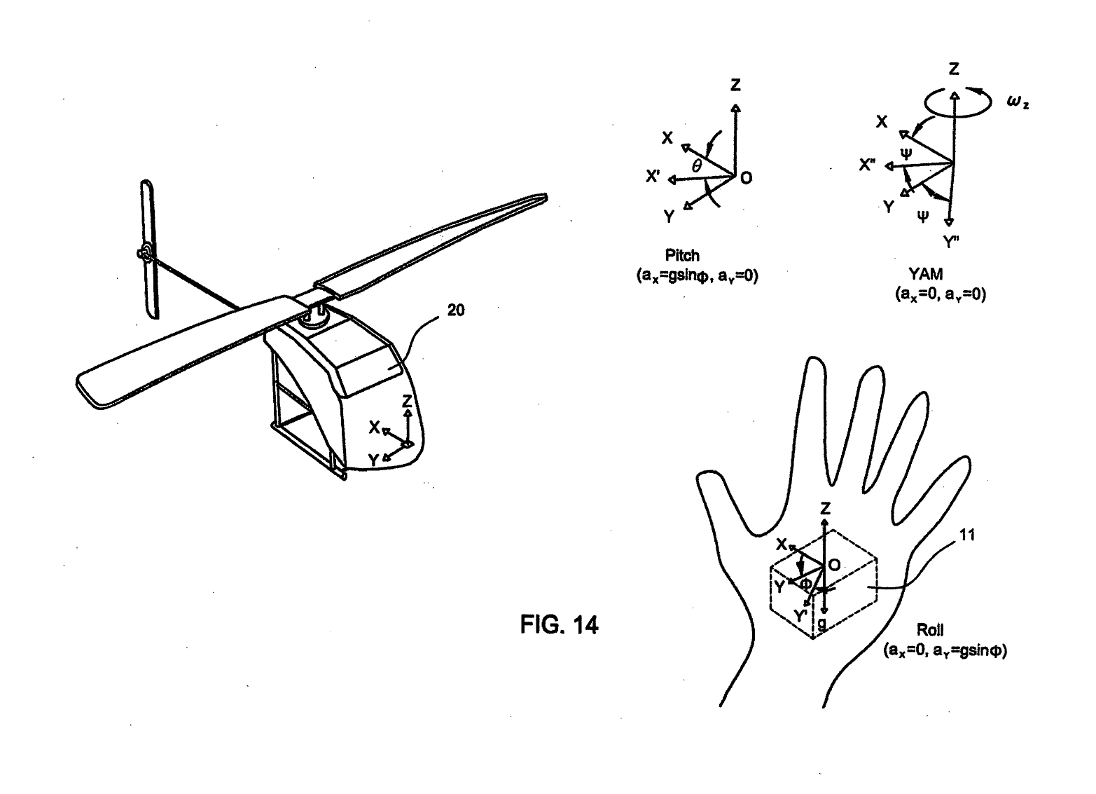

FIG. 14 is a schematic diagram of another embodiment of the present invention. In this embodiment, the gyroscope, accelerometer, or the tilt sensor is fixed on user's palm. Accordingly, the gyroscope is applied to detect the angular velocity ω_{z} of the YAW-axis motion of the palm, and the accelerometer or the tilt sensor is applied to detect the posture angles (θ,φ) of the palm.

It's the origin (acceleration aₓ=a_{y}=0) of the handheld controller 11 when the palm keeps forward and the Roll of Y-axis and the Pitch of X-axis keeps horizontal. When the handheld controller 11 is moved in the Roll and Pitch directions, the posture angles (θ,φ) can be calculated from the accelerations aₓ and a_{y} by using the following equations:

$$\begin{matrix}θ ( k ) = {sin}^{- 1} \frac{{a}_{X} ( k )}{g} & ( 10 ) \\ φ ( k ) = {sin}^{- 1} \frac{{a}_{Y} ( k )}{g} & ( 11 )\end{matrix}$$

Thereafter, the amounts and directions of the motion signal are transformed into the coordinate system of the controlled object. Accordingly, the motion (Δv (left-right), Δu (back-forth), Δψ (change of the heading angle)) of the controlled object can be obtained by applying the motion (θ,φ,ω_{Z}) of the handheld controller at the following equation:

$$\begin{matrix}{[ \begin{matrix}Δ u \\ Δ v \\ Δ ψ\end{matrix} ]}_{object \cdot frame} = [ \begin{matrix}{S}_{X} {S}_{2 X} & 0 & 0 \\ 0 & {S}_{Y} {S}_{2 Y} & 0 \\ 0 & 0 & {S}_{Z} {S}_{2 Z}\end{matrix} ] \cdot [ \begin{matrix}θ \\ φ \\ {ω}_{Z}\end{matrix} ] \\ = {K}_{w} \cdot {S}_{aw} \cdot {[ \begin{matrix}θ \\ φ \\ {ω}_{Z}\end{matrix} ]}_{body \cdot frame}\end{matrix}$$

Where S_{aw} is the matrix for correcting the motion signals, and K_{w} is a coordinate transformation matrix. In this example, k₁₁=k₂₂=k₃₃=1, and other kᵢⱼs are zero.

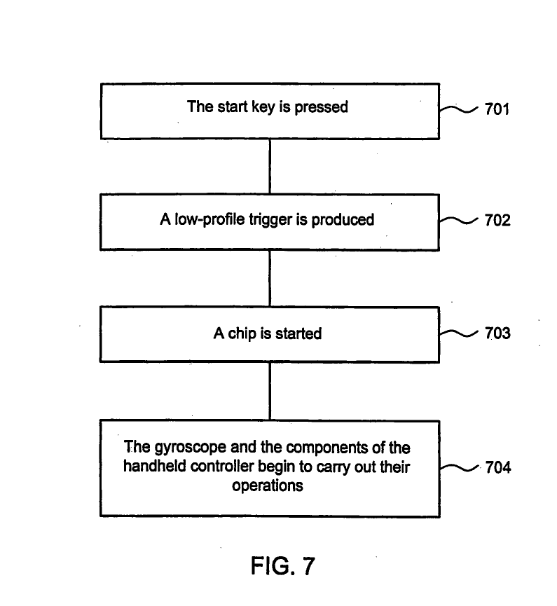

FIG. 7 is a flow chart of enabling the handheld controller. After pressing the start key (step 701), a low-profile trigger is produced (step 702), and a chip is started (step 703). Thereafter, the gyroscope and the components of the handheld controller begin to carry out their operations (step 704). Whenever the start key is released, the handheld controller will enter into a sleep mode to conserve power, which enables flexible usage and allowing the user to control the condition of the handheld controller.

Furthermore, in order to correct the deviations of the sensor such as the gyroscope, the accelerometer, or the tilt sensor, a calibration button is installed to the handheld controller. When performing the calibration procedure, the calibration button is pressed, and the single chip repeatedly collects the outputs of each axis of the sensor. The values of the outputs of each axis are averaged, and the average value of the outputs of each axis is set as the deviation of each axis. Thereafter, the average value is stored at a database. Whenever the start button is pressed, the average value is retrieved from the database to be compared with the present angular velocity. After that, the difference is sent back to the central processing unit for computation to correct the deviations.

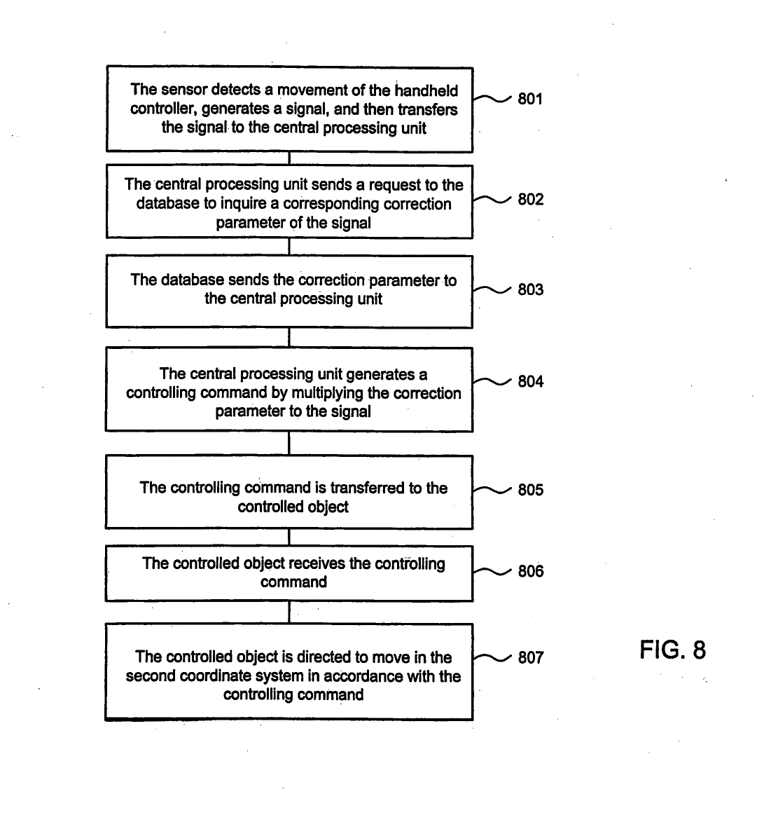

FIG. 8 is a flow chart of the method of controlling a controlled object by detecting a movement of a handheld controller. First, the sensor detects a movement of the handheld controller, generates a signal, and then transfers the signal to the central processing unit (step 801). The signal contains coordinates of the movement in a first coordinate system.

After that, the central processing unit sends a request to the database to inquire a corresponding correction parameter of the signal (step 802). After receiving the request, the database sends the correction parameter to the central processing unit (step 803).

After receiving the correction parameter, the central processing unit generates a controlling command by multiplying the correction parameter to the signal (step 804), wherein said controlling command comprises coordinates in a second coordinate system. After transferring the controlling command to the controlled object (step 805), the controlled object receives the controlling command (step 806). Finally, the controlled object is directed to move in the second coordinate system in accordance with the controlling command (step 807).

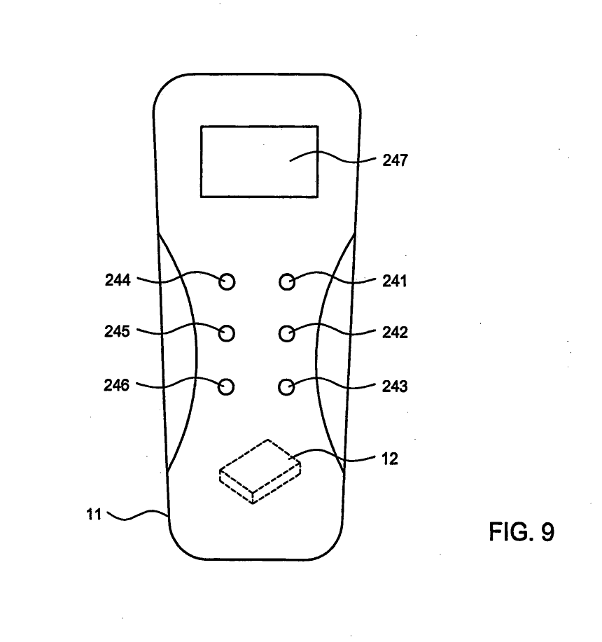

FIG. 9 is a schematic diagram of the integrated remote-control apparatus of the present invention. The handheld controller 11 moves freely to control the controlled object as other embodiments. In addition, other keys such as a directory key 241, a start/pause key 242, a stop key 243, a volume-up key 244, a volume-down key 245, and selection key 246, and a monitor 247 to show the controlling condition are integrated to the handheld controller 11 to achieve a multi-tasking remote control integration.

According to one embodiment of the present invention, the handheld controller 11 is a handheld remote controller, and the controlled object is a remote-controlled airplane 20.

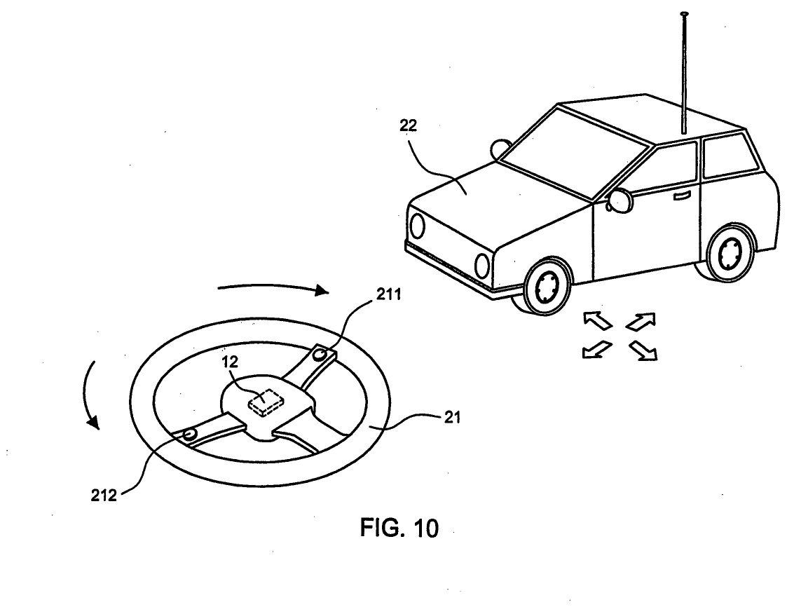

FIG. 10 is a schematic diagram of another embodiment of the present invention. According to this embodiment, the handheld controller 11 is a steering wheel 21, and the controlled object is a controlled vehicle 22. By counterclockwise rotating the steering wheel 21, the controlled vehicle 22 will turn left. On the contrary, by rotating clockwise the steering wheel 21, the controlled vehicle 22 will turn right. In addition, a forward key 211 and a backward key 212 are integrated to the steering wheel 21 as well. By pressing the forward key 211, the controlled vehicle 22 will move forward. On the contrary, by pressing the backward key 212, the controlled vehicle 22 will move backward.

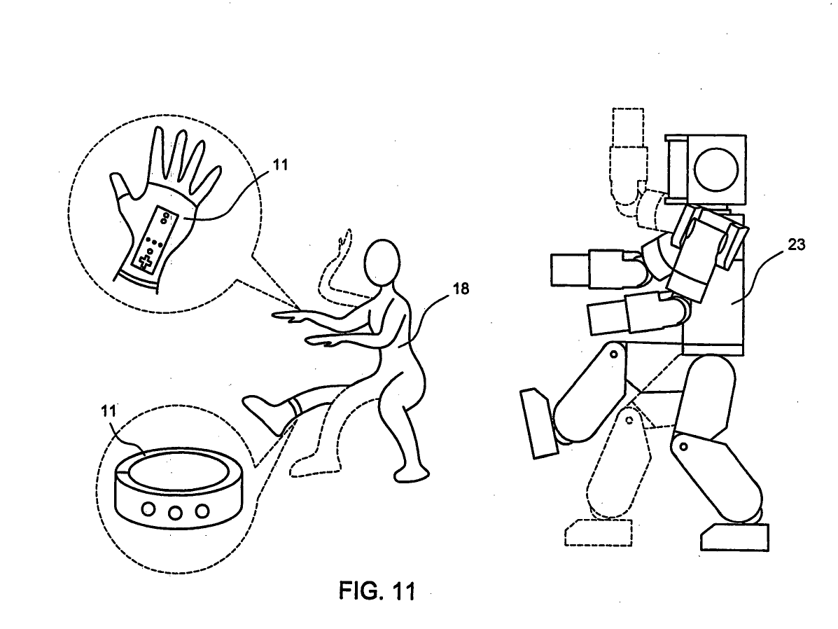

FIG. 11 is a schematic diagram of another embodiment of the present invention. According to this embodiment, the handheld controller 11 is a clothing structure for a human body 18, and the controlled object is a controlled robot 23. According to one example of this embodiment, the clothing structure is comprised of gloves and foot rings. Once the person wearing the clothing structure moves his/her hands or feet, the controlled robot 23 will imitate the similar movement.

According to one embodiment of the present invention, a function key is installed to the handheld controller 11. The function key is a roller, a press button, or a switch.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of controlling a controlled object by detecting a movement of a handheld controller, wherein said handheld controller comprises a central processing unit, a sensor, and a database, wherein said sensor is operated to detect said movement of said handheld controller, and said database is applied to store correction parameters, comprising,
applying said sensor to detect a movement of said handheld controller, to generate a signal, and to transfer said signal to said central processing unit, wherein said signal contains coordinates of said movement in a first coordinate system;
Applying said central processing unit to send a request to said database to inquire a corresponding correction parameter of said signal;
Applying said database to send said correction parameter to said central processing unit;
applying said central processing unit to generate a controlling command by multiplying said correction parameter to said signal, wherein said controlling command comprises coordinates in a second coordinate system; and
transferring said controlling command to said controlled object to direct said controlled object to move in said second coordinate system in accordance with said controlling command.

2. The method of claim 1, wherein said sensor is a gyroscope.

3. The method of claim 2, wherein said first coordinate system is an angular movement in body frame.

4. The method of claim 3, wherein said second coordinate system is a linear movement in object frame.

5. The method of claim 1, wherein said sensor is an accelerometer.

6. The method of claim 5, wherein said first coordinate system is an angular movement in body frame.

7. The method of claim 6, wherein said second coordinate system is a linear movement in object frame.

8. The method of claim 1, wherein said sensor is a gyroscope combining an accelerometer.

9. The method of claim 8, wherein said first coordinate system is a three-dimensional coordinate system, in which two coordinate axes are angular coordinate axes, and one coordinate axis is an angular velocity coordinate axis.

10. The method of claim 8, wherein said second coordinate system is a three-dimensional coordinate system, in which two coordinate axes are displacement coordinate axes, and one coordinate axis is an angular coordinate axis.

11. The method of claim 1, wherein said handheld controller is a three-dimensional mouse, and said controlled object is a cursor on a monitor.

12. The method of claim 1, wherein said handheld controller is a handheld remote controller, and said controlled object is a remote-controlled airplane.

13. The method of claim 1, wherein said handheld controller is a steering wheel, and said controlled object is a controlled vehicle.

14. The method of claim 1, wherein said handheld controller is a clothing structure for a human body, and said controlled object is a controlled robot.

15. The method of claim 1, further comprising a step of starting or stopping the step of applying said sensor to detect a movement of said handheld controller by using an enabling signal or a disabling signal.

16. A handheld controller, comprising:
a central processing unit;
a sensor for detecting a movement of said handheld controller, generating a signal, and sending said signal to said central processing unit; wherein
said signal contains coordinates of said movement in a first coordinate system;
a database for storing correction parameters; wherein:
said central processing unit sends a request to said database to inquire a corresponding correction parameter of said signal after receiving said signal;
said database sends said correction parameter to said central processing unit after receiving said request;
said central processing unit generates a controlling command by multiplying said correction parameter to said signal, wherein said controlling command comprises coordinates in a second coordinate system; and
a communication apparatus for transferring said controlling command to a controlled object.

17. The handheld controller of claim 16, wherein said controlled object moves in said second coordinate system in accordance with said controlling command after receiving said controlling command.

18. The handheld controller of claim 17, wherein said sensor is a multi-axis gyroscope.

19. The handheld controller of claim 18, wherein said first coordinate system is an angular velocity coordinate system.

20. The handheld controller of claim 19, wherein said second coordinate system is a displacement coordinate system.

21. The handheld controller of claim 17, wherein said sensor is an accelerometer.

22. The handheld controller of claim 21, wherein said first coordinate system is an angular displacement coordinate system.

23. The handheld controller of claim 22, wherein said second coordinate system is a displacement coordinate system.

24. The handheld controller of claim 17, wherein said sensor is a gyroscope combining an accelerometer.

25. The handheld controller of claim 24, wherein said first coordinate system is a three-dimensional coordinate system, in which two coordinate axes are angular displacement coordinate axes, and one coordinate axis is an angular velocity coordinate axis.

26. The handheld controller of claim 25, wherein said second coordinate system is a three-dimensional coordinate system, in which two coordinate axes are linear displacement coordinate axes, and one coordinate axis is an angular displacement coordinate axis.

27. The handheld controller of claim 17, further comprising a start button and a calibration button, wherein said sensor starts to detect said movement of said handheld controller in said first coordinate system after pressing said start button, and a user's wrist or elbow joint works as a fulcrum to move or rotate said handheld controller in any posture, so that said controlled object performs a corresponding two-dimensional or three-dimensional movement.

28. The handheld controller of claim 27, wherein said sensor is enabled or disabled by pressing or releasing said start button.

29. The handheld controller of claim 17, wherein function keys are installed to said handheld controller.

30. The handheld controller of claim 29, wherein said function key is a roller, a press button, or a switch.

31. The handheld controller of claim 16, wherein said first coordinate system is set on a wrist, an elbow, a shoulder, or other position of human being.
